(19) United States
(12) Patent Application Publication
(10) Pub. No.: US 2013/0097438 A1
(43) Pub. Date: Apr. 18, 2013

(54) INFORMATION PROCESSING DEVICE AND MANAGEMENT METHOD OF POWER SAVING MODE

(71) Applicant: Murata Machinery, Ltd., Kyoto-shi (JP)

(72) Inventor: Toshinari AGATA, Kyoto-shi (JP)

(73) Assignee: MURATA MACHINERY, LTD., Kyoto-shi (JP)

(21) Appl. No.: 13/628,891

(22) Filed: Sep. 27, 2012

(30) Foreign Application Priority Data
Oct. 17, 2011 (JP) 2011-228321

(51) Int. Cl. G06F 1/32

(52) U.S. Cl. 713/320

(57) ABSTRACT

In an information processing device, when shifting to a power saving mode, a volatile storage unit is controlled to continuously hold a program loaded to the volatile storage unit even in the power saving mode, and a logical value indicating the power saving mode is set to an input/output port of a third control unit. At time of activation, a second control unit determines if the logical value indicating the power saving mode has been set to the input/output port, and when the logical value has been set, recognizes the activation as a return from the power saving mode and executes the program held in the volatile memory, and when the logical value has not been set, recognizes the activation as a normal activation, loads the program held in the nonvolatile memory to the volatile memory and executes the loaded program.

### CROSS-REFERENCE TO RELATED APPLICATIONS

The present application claims priority under 35 U.S.C. 119 to Japanese Patent Application No. 2011-228321, filed on Oct. 17, 2011, which application is hereby incorporated by reference in its entirety.

### BACKGROUND OF THE INVENTION

1. Field of the Invention

The present invention relates to an information processing device and a management method of a power saving mode of the information processing device.

2. Description of the Related Art

In an information processing device, such as a personal computer, a facsimile device or the like, control is performed to automatically shift from a normal mode to a power saving mode when an idling state of a certain time is continued in order to respond to the demand of power saving. The power saving mode is a mode of operating while suppressing the power consumption to be less than the normal mode by stopping the power supply or the clock provision to some elements of the information processing device.

In the information processing device having a function of communicating with other equipment through a communication network, the circuit related to the communication network is preferably operating on a constant basis even during the power saving mode to respond to the demand from the communication network that may occur at any time. However, adequate power saving cannot be realized if current is flowed on a constant basis to the circuit related to the communication network.

Therefore, a technique of returning from the power saving mode as quickly as possible when the demand from the communication network is made without flowing current to the circuit related to the communication network while in the power saving mode has conventionally been used. In this conventional technique, a memory control device using a self-refresh function of DDR SDRAM (Double Data Rate Synchronous DRAM, hereinafter simply referred to as “DDR memory”) as the RAM is disclosed. The DDR memory can hold data at small power by being in a self-refresh state. Therefore, in the conventional technique, high speed activation is realized by saving the necessary information in the DDR memory before shifting to the power saving mode, putting the DDR in the self-refresh state during the power saving mode, and releasing the self-refresh state and reusing the information saved in the DDR memory when returned from the power saving mode.

However, the DDR memory is in a state that is capable of holding the information but not enabling the access to the holding information in the self-refresh state. Thus, the information saved in the DDR memory cannot be used to determine whether or not to release the self-refresh state. As a result, the control unit needs to determine whether the information saved in the DDR memory is effective information when the information processing device is activated. This corresponds to determining whether or not the information is saved before shifting to the power saving mode. To achieve this, a storage unit other than the DDR memory needs to be arranged and a flag indicting whether or not the effective information is saved in the DDR memory is to be stored therein. If a special nonvolatile storage unit such as a hard disc is provided to store such flag, the high speed return from the power saving mode is inhibited, and the cost may increase.

### SUMMARY OF THE INVENTION

In view of such problems, preferred embodiments of the present invention provide an information processing device that is capable of returning from a power saving mode at high speed without increasing cost.

One aspect of an information processing device according to a preferred embodiment of the present invention relates to an information processing device capable of operating in a power saving mode, the information processing device including a first control unit, a nonvolatile storage unit, a second control unit, a volatile storage unit, and an input/output port. The first control unit is adapted to control shifting to the power saving mode and return from the power saving mode. The nonvolatile storage unit stores a program. The second control unit is adapted to load the program stored in the nonvolatile storage unit to the volatile storage unit and execute the loaded program. The input/output port is adapted to hold a set logical value even during the power saving mode. The first control unit controls, when shifting to the power saving mode, the volatile storage unit through the second control unit to continuously hold the program loaded in the volatile storage unit even in the power saving mode and sets the logical value indicating the power saving mode to the input/output port, and then starts the shift to the power saving mode. The first control unit also controls the second control unit so that, when the information processing device is activated, the second control unit can determine if the logical value indicating the power saving mode has been set to the input/output port, and when the logical value has been set to the input/output port, the second control unit recognizes the activation as the return from the power saving mode and executes the program held in the volatile storage unit, and when the logical value has not been set to the input/output port, the second control unit recognizes the activation as a normal activation that is not the return from the power saving mode, and loads the program held in the nonvolatile storage unit to the voltage storage unit and executes the loaded program.

When shifting to the power saving mode, the logical value indicating the power saving mode is set to the input/output port adapted to continuously hold the logical value even during the power saving mode. In the activation of the information processing device, whether the return from the power saving mode or the normal activation such as power ON is determined according to the logical value set to the input/output port. That is, in the activation of the information processing device, whether the information held in the volatile storage unit is valid information or not can be determined by simply referencing the set value of the input/output port having one bit.

Thus, in the return from the power saving mode, the information processing device can be activated by reusing the information saved in the volatile storage unit by simply referencing the input/output port having one bit. Therefore, an expensive readable and writable nonvolatile storage unit such as a hard disc or a memory IC does not need to be arranged to set the flag related to the power saving mode. As a result, an increase in cost can be prevented and high speed return from the power saving mode can be realized.

The second control unit includes a register arranged to store information, saves the information stored in the register in the volatile storage unit and sets a flag indicating the power saving mode in the volatile storage unit before shifting to the power saving mode, and determines if the flag has been set in the volatile storage unit when the information processing device is activated, and restores the information saved in the volatile storage unit in the register when the flag has been set in the volatile storage unit. Thus, the second control unit is restored to the state before shifting to the power saving mode and the operation is resumed in the return from the power saving mode by referencing the flag saved in the volatile storage unit after the access to the volatile storage unit is enabled. The process for transitioning the second control unit to such a state is thus not necessary, and the returning process from the power saving mode can be reduced.

The volatile storage unit has a self-refresh function of not being able to input nor output the saved information but being able to continuously store the information; and the first control unit may control, when shifting to the power saving mode, the volatile storage unit through the second control unit to continuously store the loaded program even in the power saving mode by having the volatile storage unit perform self-refresh, and control, when the information processing device is activated, the second control unit so that when the logical value has been set to the input/output port, the second control unit releases the self-refresh in the volatile storage unit and then executes the program held in the volatile storage unit. The DDR memory having the self-refresh function capable of continuously storing the information while saving power thus can be adopted for the volatile storage unit.

A third control unit, which continues to operate even in the power saving mode, may be further provided, wherein the input/output port may be a port arranged in the third control unit. A port of the third control unit of extremely low power consumption to perform the minimum process during the power saving mode thus can be used for the input/output port. Thus, a special storage unit does not need to be arranged as a storage area of the flag to manage the power saving mode.

Another preferred embodiment of the present invention provides a main substrate including a circuit mounted thereon to perform a control of image formation, and a network substrate including an interface circuit mounted thereon to perform communication, wherein the nonvolatile storage unit, the volatile storage unit, and the second control unit is preferably mounted on the network substrate, and the input/output port is preferably mounted on the main substrate. Thus, the management method of the power saving mode according to a preferred embodiment of the present invention can be applied to the image forming device such as a facsimile device including the main substrate including a circuit that is mounted thereon and arranged and programmed to control image formation and a network substrate mounted including an interface circuit that is mounted thereon and arranged to perform communication.

One aspect of a management method of a power saving mode according to a preferred embodiment of the present invention relates to a management method of a power saving mode of an information processing device capable of operating in the power saving mode, the management method including the following steps. First, when shifting to the power saving mode, a volatile storage unit is controlled to continuously store a program loaded from a nonvolatile storage unit to the volatile storage unit even in the power saving mode and a logical value indicating the power saving mode is set to an input/output port, and then a shift to the power saving mode is activated. Secondly, when the information processing device is activated, whether or not the logical value indicating the power saving mode has been set to the input/output port is determined, and when the logical value has been set to the input/output port, return from the power saving mode is recognized and the program held in the volatile storage unit is executed, and when the logical value has not been set to the input/output port, normal activation that is not the return from the power saving mode is recognized, the program held in the nonvolatile storage unit is loaded to the volatile storage unit and the loaded program is executed.

Thus, in the return from the power saving mode, the information processing device can be activated by reusing the information saved in the volatile storage unit by simply referencing the input/output port having one bit. Therefore, an expensive readable and writable nonvolatile storage unit such as a hard disc or a memory IC does not need to be arranged to set the flag related to the power saving mode. As a result, an increase in cost can be avoided and high speed return from the power saving mode can be realized.

Preferred embodiments of the present invention are not only realized as the information processing device and the management method of the power saving mode, but also may be realized as a program that causes a computer to execute the steps of the method. Preferred embodiments of the present invention may also be realized as a recording medium such as a computer readable CD-ROM having the relevant program stored or recorded thereon. Furthermore, preferred embodiments of the present invention may also be realized as information, data, or signal indicating the program. Moreover, the program, information, data, and signal may be distributed through a communication network such as the Internet.

According to various preferred embodiments of the present invention, an information processing device enabling high speed return from the power saving mode without increasing the cost is realized.

Therefore, even if the power supply to the circuit related to the communication network is stopped during the power saving mode, return from the power saving mode can be carried out at high speed when a request from the communication network is made. Therefore, the practical value of preferred embodiments of the present invention is extremely high especially in present day where the information processing device having a connection function with the communication network is in wide use.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a view illustrating a configuration of a communication system including an information processing device according to a preferred embodiment of the present invention.

FIG. 2 is a block diagram illustrating hardware configuration of the information processing device according to a preferred embodiment of the present invention.

FIG. 3A is a block diagram illustrating a detailed module configuration of a main substrate illustrated in FIG. 2, and FIG. 3B is a block diagram illustrating a detailed module configuration of a network substrate illustrated in FIG. 2.

FIG. 4 is a flowchart illustrating the operation in a case where the information processing device shifts to the power saving mode.

FIG. 5 is a sequence chart illustrating the operation and the communication of the main modules of the main substrate and the network substrate when the information processing device shifts to the power saving mode.

FIGS. 6A and 6B are views illustrating communication between the main modules of the main substrate and the network substrate when the information processing device shifts to the power saving mode.

FIG. 7 is a flowchart illustrating the operation in a case where the information processing device is activated.

FIGS. 8A and 8B are views illustrating communication between the main modules of the main substrate and the network substrate when the information processing device is activated.

### DETAILED DESCRIPTION OF THE PREFERRED EMBODIMENTS

Preferred embodiments of the present invention will be hereinafter described in detail using the drawings. The preferred embodiments described below are all preferred specific examples of the present invention. Configuring elements, arrangement positions and connection modes of the configuring elements, orders of operation, and the like described in the preferred embodiments below are merely examples and are not intended to limit the present invention.

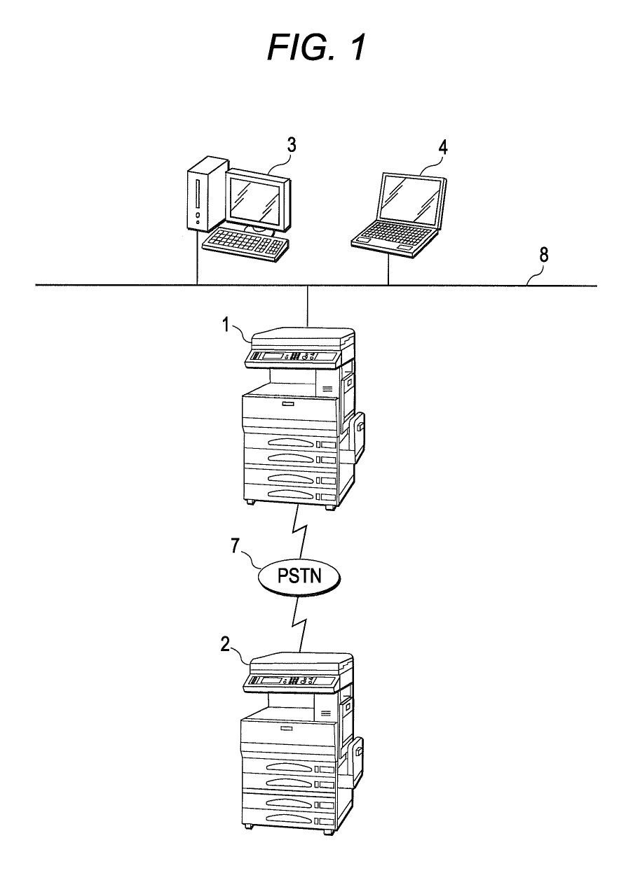

FIG. 1 is a view illustrating a configuration of a communication system including an information processing device 1 according to a preferred embodiment of the present invention. In the communication system, the information processing device 1 preferably is an image forming device such as an MFP (MultiFunction Peripheral) having the function of facsimile transmission and reception. The information processing device 1 is connected to a counterpart information processing device 2 corresponding to the counterpart destination of transmission and reception of the facsimile through a PSTN (Public Switched Telephone Networks) 7, and is connected to terminal devices 3 and 4 through a LAN 8.

The terminal devices 3 and 4 are terminal devices that access the information processing device 1 serving as a Web server through the LAN 8 as a Web client, and provide various types of instructions and perform various types of setting with respect to the information processing device 1, and that also function as a remote operation panel of the information processing device 1.

The counterpart information processing device 2 is, for example, an image forming device having the same function as the information processing device 1 according to a preferred embodiment of the present invention.

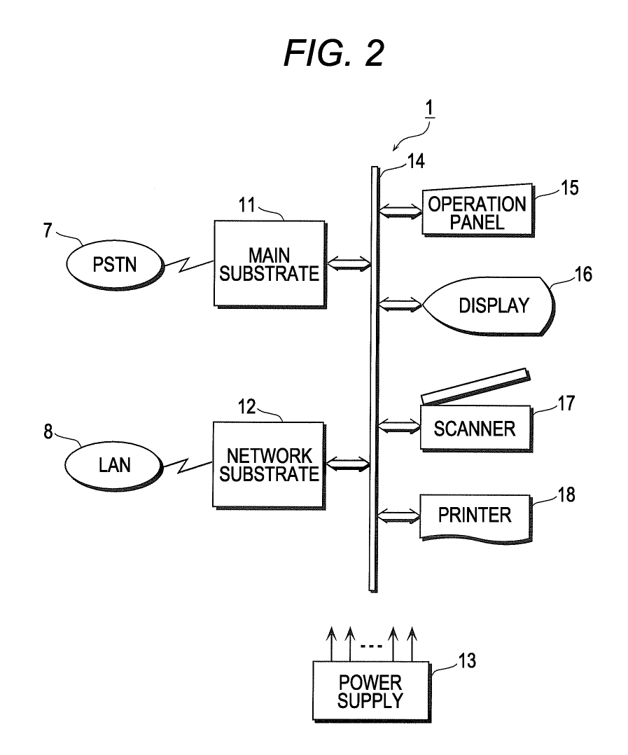

The information processing device 1 is an example of an information processing device according to a preferred embodiment of the present invention capable of operating in the power saving mode, and is an image forming device such as an MFP having the function of the Web server, for example. As illustrated in FIG. 2, the information processing device 1 preferably includes a main substrate 11 connected to the PSTN 7, a network substrate 12 connected to the LAN 8, a power supply 13, a bus 14, an operation panel 15, a display 16, a scanner 17, and a printer 18 as a hardware configuration, for example. The main substrate 11, the network substrate 12, the operation panel 15, the display 16, the scanner 17, and the printer 18 are adapted to operate when receiving power from the power supply 13 controlled by the main substrate 11 and are connected to each other by the bus 14.

The operation panel 15 is a panel that can accept operations from the user, and for example, is a numerical key, a one-touch transmission key, a touch panel for pushing a soft button displayed on the display 16 and the like.

The display 16 preferably is a liquid crystal display device (LCD) or other suitable display device, and is used to interact with the user. The display 16 displays an operation state of the information processing device 1.

The scanner 17 preferably is an image scanning device that optically scans the content of the document for facsimile transmission or copy output to the printer 18 with the CCD or the like, and generates image data.

The printer 18 is a printing device, and for example, is adapted to print and output the image data (facsimile reception data) transmitted from the counterpart information processing device 2, the scanned content from the scanner 17, the operation state of the information processing device 1, and the like.

The main substrate 11 is a circuit substrate that controls the entire information processing device 1 (network substrate 12, power supply 13, operation panel 15, display 16, scanner 17, printer 18) and performs facsimile transmission and reception with the counterpart information processing device 2 through the PSTN 7. That is, in the present preferred embodiment, the main substrate 11 is a substrate having mounted thereon a circuit that is arranged and programmed to perform the control of image formation.

The network substrate 12 is a circuit substrate that performs a process related to the communication network by communicating with the terminal devices 3 and 4 through the LAN 8. That is, the network substrate 12 is a substrate with an interface circuit to perform communication mounted thereon.

The power supply 13 is a power supply source capable of supplying power and stopping the supply of power independently for each configuring element of the information processing device 1 under the control of the main substrate 11.

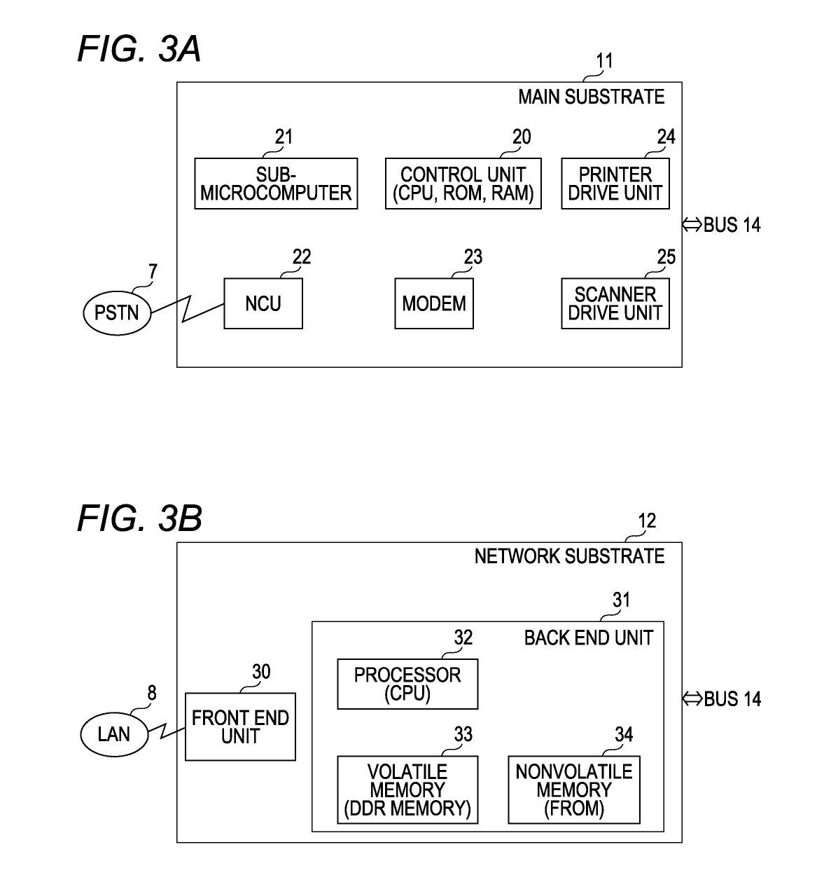

FIG. 3A is a block diagram illustrating a detailed module configuration of the main substrate 11 illustrated in FIG. 2, and FIG. 3B is a block diagram illustrating a detailed module configuration of the network substrate 12 illustrated in FIG. 2.

The main substrate 11 preferably includes a control unit 20 (first control unit), a sub-microcomputer 21 (third control unit), an NCU 22, a modem 23, a printer drive unit 24, and a scanner drive unit 25, for example.

The control unit 20 is a processing unit arranged and programmed to control the network substrate 12, the power supply 13, the operation panel 15, the display 16, the scanner 17, and the printer 18. Specifically, the control unit 20 is preferably configured by a ROM to store a control program, a CPU that executes the control program, a RAM that provides a temporary work region for the execution, and the like. With respect to the power saving mode, the control unit 20 controls the power supply 13 to perform the control to shift the information processing device 1 to the power saving mode and the control to return the information processing device 1 from the power saving mode.

The sub-microcomputer 21 preferably is a one-chip microcomputer of extremely low power consumption in which the power is supplied even during the power saving mode so that the minimum required process or processes in the power saving mode is continuously executed. The sub-microcomputer 21 includes a plurality of input/output ports that hold a set logical value and output the same to an external device, and receive a signal from an external device and perform monitoring in addition to a register that temporarily stores information and a calculation unit. One specific input/output port (specifically, output port) of the input/output ports of the sub-microcomputer 21 is connected to a processor 32 so that the set value is detected by the processor 32.

The NCU 22 is a circuit terminating device connected to the PSTN 7.

The modem 23 is a facsimile modem that modulates the image data to transmit to the external device through the NCU 22 and demodulating the image data received through the NCU 22 from the external device.

The printer drive unit 24 is a drive circuit that is arranged and programmed to control printing by the printer 18.

The scanner drive unit 25 is a drive circuit that is arranged and programmed to control the scanning of the document by the scanner 17.

The network substrate 12 includes a front end unit 30 and a back end unit 31.

The front end unit 30 includes a communication adapter to connect the information processing device 1 and the LAN 8. The front end unit 30 continues to be supplied with power even during the power saving mode, and monitors whether a return event from the power saving mode such as a request from the communication network through the LAN 8 has occurred.

The back end unit 31 is a processing unit that performs various types of processing related to the communication network, and includes the processor 32 (second control unit), a volatile memory 33 (volatile storage unit), and a nonvolatile memory (nonvolatile storage unit) 34.

The processor 32 preferably is a CPU including a register that temporarily stores information, a calculation unit, an MMU (Memory Management Unit), a TLB (Translation Look-aside Buffer), and the like. The processor 32 loads a program held in the nonvolatile memory 34 to the volatile memory 33, executes the loaded program of the volatile memory 33, and writes data in the volatile memory 33 and reads out the data therefrom based on the execution. The processor 32 is connected to one input/output port (output port herein) of the sub-microcomputer 21, and detects the value set to the relevant input/output port to determine whether or not the information processing device 1 is activated from the power saving mode when activated.

The volatile memory 33 is a volatile memory (DDR memory herein), and provides a temporary storage region. The volatile memory 33 includes a memory controller (not illustrated) that controls a self-refresh function. That is, the volatile memory 33 has a self-refresh function of continuously holding the information at extremely low power consumption, although input and output of the held information cannot be carried out. Thus, the volatile memory 33 functions as the readable and writable RAM in the normal state (operation at normal power consumption), but merely holds the data in the self-refresh state (operation at extremely low power consumption).

The nonvolatile memory 34 preferably is a nonvolatile memory (Flash ROM herein) to hold in advance the program to be executed by the processor 32. The disc storage unit may be used for the nonvolatile storage unit.

The modules that continue to operate by receiving power from the power supply 13 even if the information processing device 1 is shifted to the power saving mode under the control of the control unit 20 preferably are the sub-microcomputer 21, the front end unit 30, and the volatile memory 33 in the self-refresh state. The reasons are as follows. In the power saving mode, the sub-microcomputer 21 monitors whether an event to return from the power saving mode has occurred. The front end unit 30 detects the request from the communication network sent from the LAN 8 as one of the events. The volatile memory 33 enters the self-refresh state and continues to hold the program and data held immediately before the transition to the power saving mode during the power saving mode to increase the speed of return from the power saving mode.

The characteristic functions of the information processing device 1 in the present preferred embodiment configured as above are as follows.

When shifting to the power saving mode, the control unit 20 controls the volatile memory 33 through the processor 32 so that the volatile memory 33 continues to hold the loaded program even in the power saving mode, and starts to shift to the power saving mode after setting the logical value indicating the power saving mode to one of the input/output ports of the sub-microcomputer 21. The start of shifting to the power saving mode includes controlling the power supply 13 to stop the power supply to some modules. When the information processing device 1 is activated (power ON or return from power saving mode), the control unit 20 controls the power supply 13 and activates (i.e., controls) the processor 32. Controlling the power supply 13 includes starting the power supply to the module, to which the power supply is stopped. The processor 32 that has been activated determines if the logical value indicating the power saving mode has been set to one of the input/output ports of the sub-microcomputer 21. When the logical value is set to the input/output port as a result, the processor 32 recognizes this as the return from the power saving mode and executes the program held in the volatile memory 33. When the logical value has not been set to the input/output port, the processor 32 recognizes the activation as the normal activation (activation from power ON), and loads the program held in the nonvolatile memory 34 to the volatile memory 33 and executes the loaded program.

Thus, in the return from the power saving mode, the information saved in the volatile memory 33 can be reused to activate the information processing device 1 by simply referencing the input/output port having one bit. An expensive readable and writable nonvolatile memory such as a hard disc or a memory IC does not need to be arranged to set the flag related to the power saving mode.

The processor 32 saves the information (information stored in internal register and TLB, etc.) related to the internal state in the volatile memory 33 and sets the flag indicating the power saving mode in the volatile memory 33 before shifting to the power saving mode. When the information processing device 1 is activated, the processor 32 determines if the flag has been set in the volatile memory 33. When the flag has been set in the volatile memory 33 as a result, the processor 32 recognizes the activation as the return from the power saving mode and restores the information saved in the volatile memory 33 in the internal register, TLB, and the like.

Thus, after the access to the volatile memory 33 is enabled, the flag saved in the volatile memory 33 is referenced so that the processor 32 is restored to the state before the shift to the power saving mode and the operation is resumed in the return from the power saving mode. Thus, the process for transitioning the processor 32 to the relevant state becomes unnecessary, and the returning process from the power saving mode is shortened.

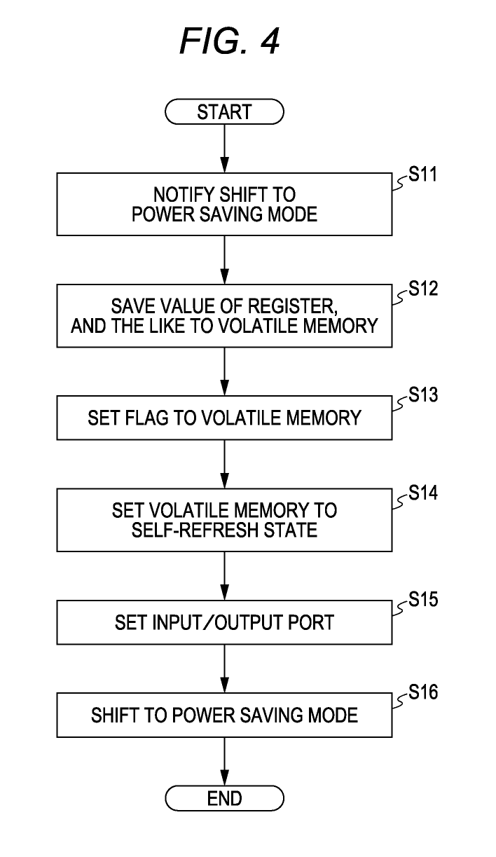

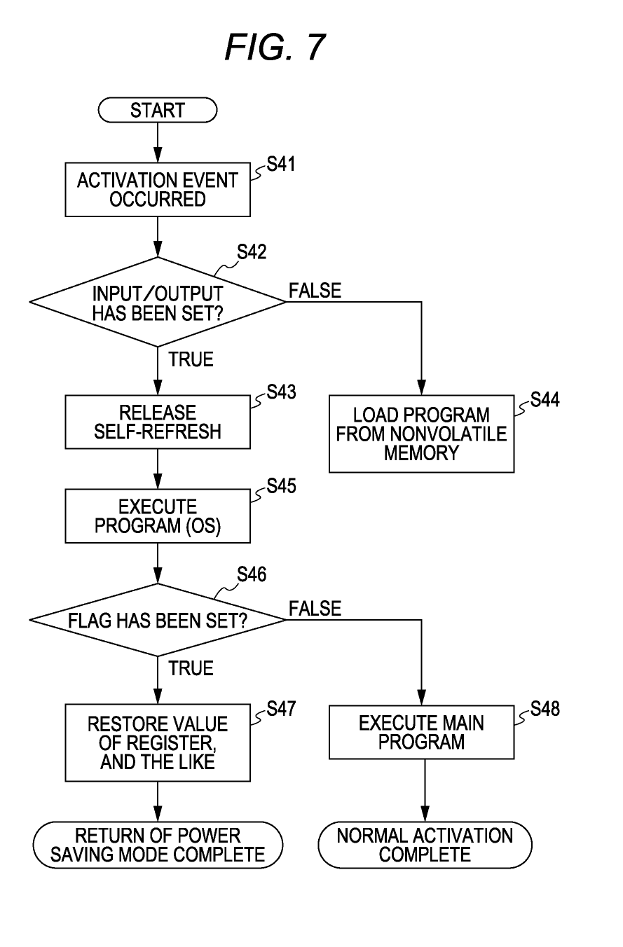

As described above, when shifting to the power saving mode, the information processing device 1 sets the information related to the shift to the power saving mode to both the input/output port and the flag (S13, S15 of FIG. 4), and checks both the input/output port and the flag when activated (S42, S46 of FIG. 7). For the following reasons, the shift to the power saving mode is stored and managed for the input/output port and the flag. If the determination as to whether or not to restore the value of the register, and the like is made based on the state of the input/output port in S46 of FIG. 7, the value of the input/output port needs to be held up to the time point when such determination is made. If reset has occurred from when the self-refresh is released (S43) until whether or not to restore the value of the register is determined (S46), the data in the volatile memory 33 may be damaged since the volatile memory 33 has released the self-refresh. However, the value of the input/output port after the reset remains as the value requiring release of self-refresh, and thus the processor 32 determines that the volatile memory 33 is being self-refreshed. In this case, the restoring process and the like are carried out using the damaged data, that is, the damaged data is used, and hence the program may operate improperly. In the present application, in order to prevent such improper operation of the program, the value of the input/output port is immediately returned to an initial value after the value of the input/output port is acquired when activated, and whether or not to restore the value of the register is determined by the flag rather than by the input/output port.

Upon shifting to the power saving mode, the processor 32 controls the volatile memory 33 so that the program loaded in the volatile memory 33 in advance continues to be held even in the power saving mode by having the volatile memory 33 perform the self-refresh under the control of the control unit 20. More specifically, the processor 32 instructs the start of the self-refresh to the memory controller. Upon returning from the power saving mode, when the logical value has been set to the input/output port of the sub-microcomputer 21, the processor 32 releases the self-refresh in the volatile memory 33 through the memory controller and then executes the program held in the volatile memory 33.

Therefore, the information processing device 1 according to the present preferred embodiment provides a unique characteristic in managing the power saving mode by executing the following steps. That is, a first step is a step of controlling the volatile memory 33 to continuously hold the program in the volatile memory 33 even in the power saving mode when shifting to the power saving mode, and setting the logical value indicating the power saving mode to the input/output port of the sub-microcomputer 21, and then starting the shift to the power saving mode. The program in the volatile memory 33 is loaded from the nonvolatile memory 34 in advance. A second step is the next step. First, when the information processing device 1 is activated, whether or not the logical value indicating the power saving mode has been set to the input/output port of the sub-microcomputer 21 is determined. When the logical value has been set to the input/output port, the program held in the volatile memory 33 is executed while recognizing the activation as the return from the power saving mode. When the logical value has not been set to the input/output port, the program held in the nonvolatile memory 34 is loaded to the volatile memory 33 and the loaded program is executed while recognizing the activation as a normal activation that is not the return from the power saving mode. This is the second step.

Therefore, upon returning from the power saving mode, the information saved in the volatile memory can be reused to activate the information processing device by simply referencing the input/output port having one bit. Therefore, an expensive readable and writable nonvolatile memory such as the hard disc or the memory IC does not need to be arranged to set the flag related to the power saving mode. As a result, an increase in the cost can be avoided and high speed return from the power saving mode can be realized.

The operation of the information processing device 1 according to the present preferred embodiment having the above characteristics will now be described.

First, the operation of the information processing device 1 at the time of shift to the power saving mode will be described.

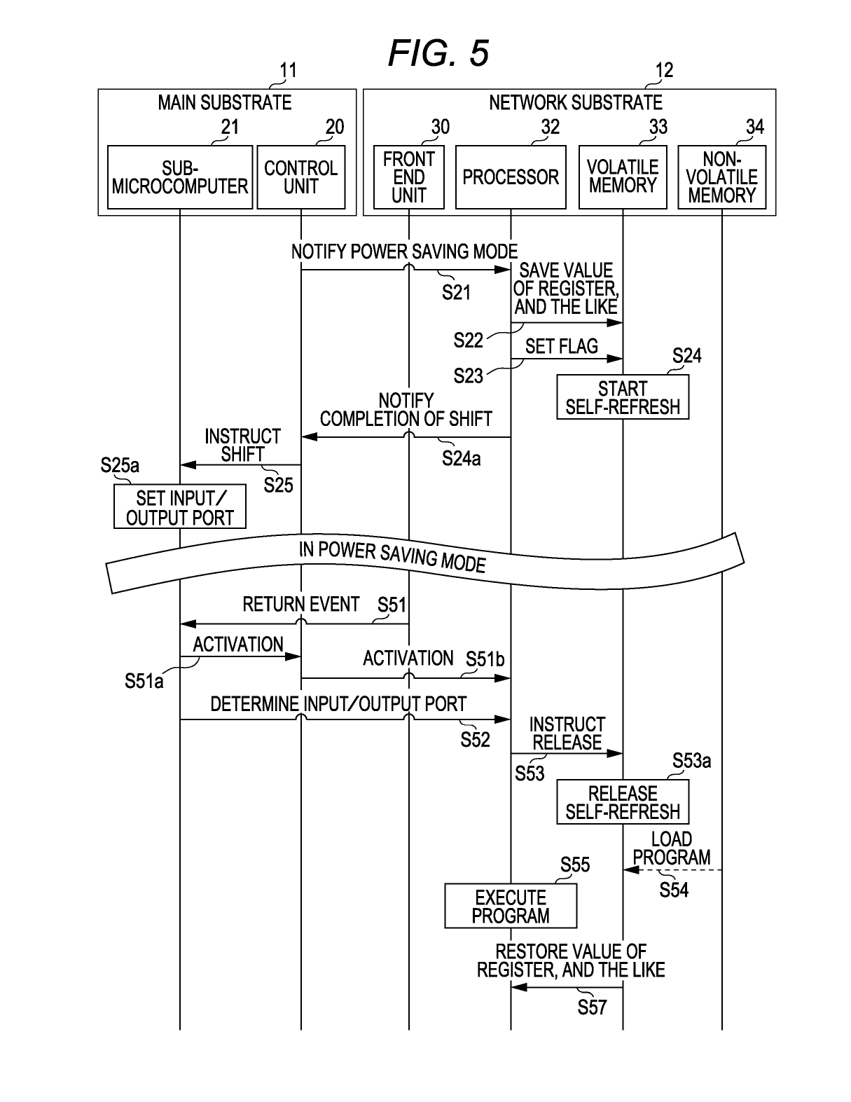

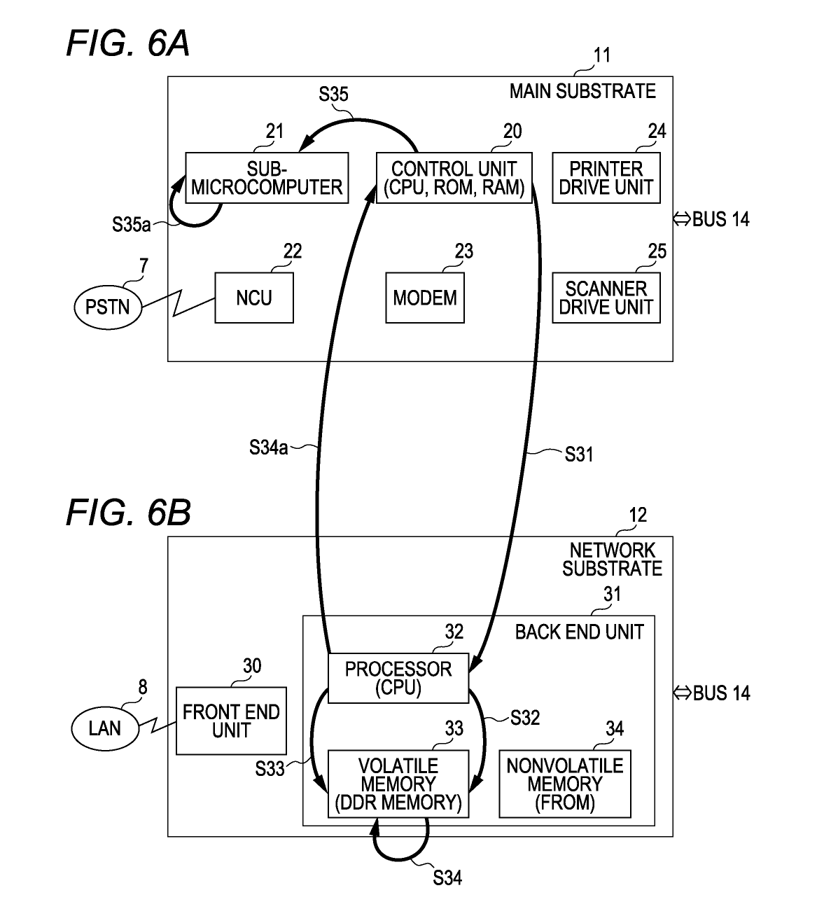

FIG. 4 is a flowchart illustrating the operation in a case where the information processing device 1 according to the present preferred embodiment shifts to the power saving mode. FIG. 5 is a sequence chart illustrating the operation and the communication of the main modules of the main substrate 11 and the network substrate 12 when the information processing device 1 according to the present preferred embodiment shifts to the power saving mode. FIGS. 6A and 6B are views illustrating communication between the main modules of the main substrate 11 and the network substrate 12 when the information processing device 1 according to the present preferred embodiment shifts to the power saving mode.

First, when detecting a state of being able to shift to the power saving mode, the control unit 20 notifies the processor 32 of shift to the power saving mode (S11 of FIG. 4, S21 of FIG. 5, S31 of FIGS. 6A and 6B).

The notified processor 32 saves the information illustrating the internal state (information stored in internal register, TLB, etc.) in the volatile memory 33 (S12 of FIG. 4, S22 of FIG. 5, and S32 of FIGS. 6A and 6B), and sets the flag indicating the power saving mode in the volatile memory 33 (S13 of FIG. 4, S23 of FIG. 5, S33 of FIGS. 6A and 6B).

Thereafter, the volatile memory 33 enters the self-refresh state by the incorporating memory controller under the control of the processor 32, and continues to hold the data immediately before and the program loaded from the nonvolatile memory 34 (S14 of FIG. 4, S24 of FIG. 5, and S34 of FIGS. 6A and 6B).

Then, when receiving the notification that the shift to the power saving mode is completed from the processor 32 (S24a of FIG. 5, S34a of FIGS. 6A and 6B), the control unit 20 instructs the sub-microcomputer 21 to shift to the power saving mode (S25 of FIG. 5, S35 of FIGS. 6A and 6B). The instructed sub-microcomputer 21 sets a logical value (e.g., “1”) indicating the power saving mode to one specific input/output port arranged inside (output port herein) (S15 of FIG. 4, S25a of FIG. 5, S35a of FIGS. 6A and 6B).

Lastly, the control unit 20 controls the power supply 13 to stop the power supply to some modules, and completes the shift to the power saving mode (S16 of FIG. 4).

When shifting to the power saving mode, the logical value indicating the power saving mode is set to one of the input/output ports of the storage unit, that is, the sub-microcomputer 21, the storage unit being independent from the volatile memory 33 capable of holding the logical value even in the power saving mode to enable high speed activation by reusing the data and the program held in the volatile memory 33. In the present application, the setting of the input/output port (S15) is carried out after carrying out S12, S13, so that drawbacks (program runaway) in a case where reset occurs before saving the value of the register or the like and setting the flag can be prevented after performing the setting of the input/output port.

The operation of the information processing device 1 at the time of activation (include normal activation from power ON) including return from the power saving mode will now be described.

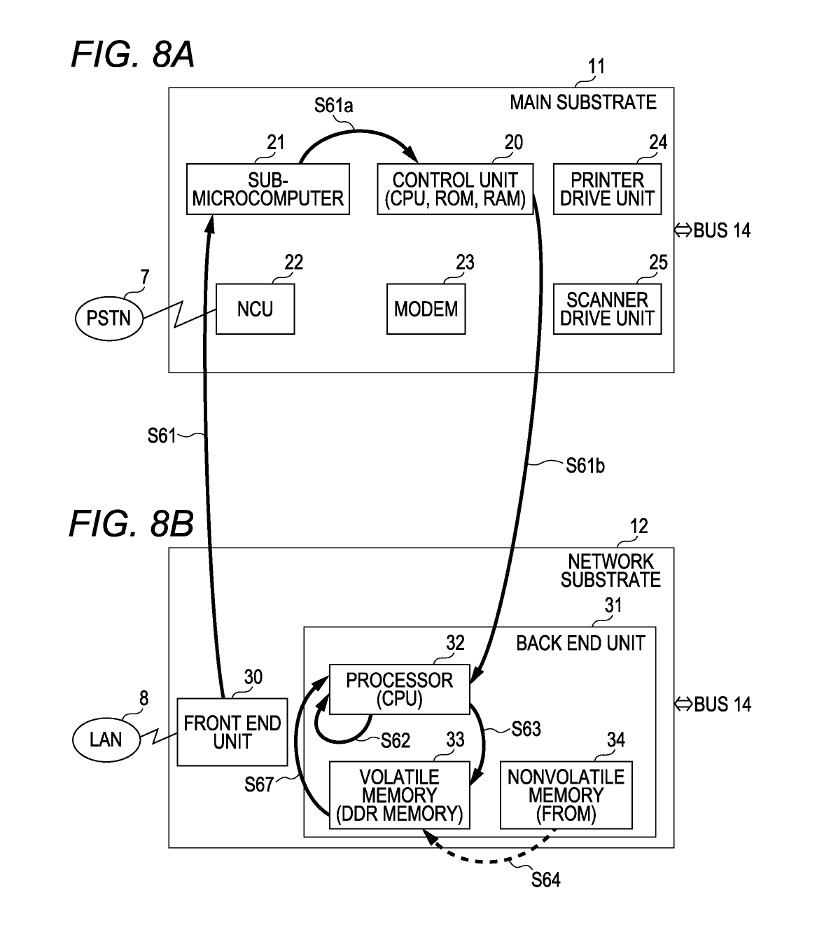

FIG. 7 is a flowchart illustrating the operation in a case where the information processing device 1 according to the present preferred embodiment is activated (power ON and return from the power saving mode). FIGS. 8A and 8B are views illustrating communication between the main modules of the main substrate 11 and the network substrate 12 when the information processing device 1 according to the present preferred embodiment is activated.

First, when detecting an event of activation (event indicating power ON or event to become a trigger for return from the power saving mode) (S41 of FIG. 7, S51 to S51a of FIG. 5, S61 to S61a of FIGS. 8A and 8B), the control unit 20 controls the power supply 13 and activates the processor 32 (S51b of FIG. 5, S61b of FIGS. 8A and 8B). As described above, controlling the power supply 13 includes starting the power supply to the module, to which the power supply is stopped. For instance, in the power saving mode, the sub-microcomputer 21 operating even in the power saving mode monitors the state of the front end unit 30 operating even in the power saving mode to monitor whether a return event from the power saving mode such as a request from the communication network has occurred (S51 of FIG. 5, S61 of FIGS. 8A and 8B). If such return event is detected, the sub-microcomputer 21 activates the control unit 20 (S51a of FIG. 5, S61a of FIGS. 8A and 8B). The activated control unit 20 then activates the processor 32 (S51b of FIG. 5, S61b of FIGS. 8A and 8B).

The activated processor 32 determines if the logical value indicating the power saving mode has been set to one of the input/output ports (one output port defined in advance) of the sub-microcomputer 21 (S42 of FIG. 7, S52 of FIG. 5, and S62 of FIGS. 8A and 8B).

When the logical value has been set to the input/output port of the sub-microcomputer 21 (TRUE in S42 of FIG. 7) as a result, the processor 32 instructs the memory controller of the volatile memory 33 to release the self-refresh state in the volatile memory 33 (S43 of FIG. 7, S53 to S53a of FIG. 5, S63 of FIGS. 8A and 8B). When the logical value has not been set to the input/output port of the sub-microcomputer 21 (FALSE in S42 of FIG. 7), the processor 32 loads the program held in the nonvolatile memory 34 to the volatile memory 33 (S44 of FIG. 7, S54 of FIG. 5, S64 of FIGS. 8A and 8B). The processor 32 then executes the program in the volatile memory 33 (S45 of FIG. 7, S55 of FIG. 5). The program in the volatile memory 33 is the basic program such as the OS held in the volatile memory 33 during the power saving mode, or the basic program such as the OS loaded from the nonvolatile memory 34 to the volatile memory 33 after the activation (S44 of FIG. 7, S54 of FIG. 5). The processor 32 immediately returns the value of the input/output port to the initial value (value indicating normal activation) after the determination of S42.

The processor 32 then determines if the flag has been set in the volatile memory 33 (S46 of FIG. 7). When the flag has been set in the volatile memory 33 as a result (TRUE in S46 of FIG. 7), the processor 32 recognizes the activation as the return from the power saving mode, reads out the information (register, TLB, etc.) held in the volatile memory 33 and sets the same inside to restore the information (S47 of FIG. 7, S57 of FIG. 5, S67 of FIGS. 8A and 8B). When the flag has not been set in the volatile memory 33 (FALSE in S46 of FIG. 7), on the other hand, the processor 32 recognizes the activation as the normal activation (from power ON), and executes the following program (main program herein) (S48 of FIG. 7).

Therefore, at the activation of the information processing device 1, whether or not the return from the power saving mode or the normal activation is determined according to the logical value set to the input/output port of the sub-microcomputer 21. The program already held in the volatile memory 33 is executed when the activation is determined as the return from the power saving mode. That is, the program already held in the volatile memory 33 is executed based on the set value of the input/output port of the storage unit independent from the volatile memory 33, that is, the sub-microcomputer 21 that continues to operate at lower power consumption even in the power saving mode instead of returning from the power saving mode by the flag or the like set in the volatile memory 33. Thus, an expensive readable and writable nonvolatile memory such as a hard disc or a memory IC does not need to be arranged to set the flag related to the power saving mode. As a result, an increase in the cost can be avoided and the speed in returning from the power saving mode can be increased.

A return from the power saving mode is detected by the flag set in the volatile memory 33 and the state information (value of register, value of TLB, etc.) of the processor 32 saved in the volatile memory 33 is restored in the processor 32. Thus, the execution of the processor 32 is continued from the state immediately before the power saving mode, the processor 32 does not need to perform the process for transitioning to such state, and the returning process from the power saving mode can be shortened.

The information processing device according to the present invention has been described above based on preferred embodiments thereof, but the present invention is not limited to such preferred embodiments. Modes obtained by implementing various modifications contrived by those skilled in the art with respect to the preferred embodiments and other modes obtained by combining the configuring elements of the preferred embodiments described above without deviating from the scope of the present invention are also encompassed within the present invention.

For instance, in the present preferred embodiment, the logical value indicating the power saving mode is preferably set to the input/output port of the sub-microcomputer 21 before shifting to the power saving mode, but the present invention is not limited to such mode. The logical value may be set to a latch circuit to receive the power supply such as the battery, or an independent universal input/output port or the like in place of the input/output port of the sub-microcomputer 21 as long as it is a storage unit including at least one bit that can continue to hold the value even during the power saving mode.

The sub-microcomputer 21, the NCU 22, and the modem 23 are mounted on the main substrate 11, but may be mounted on the network substrate 12. The present invention does not depend on the mounting position of these modules.

In the present preferred embodiment, the technique of increasing the speed of the return from the power saving mode by the information processing device represented by the facsimile device has been described, but the management technique of the power saving mode described here is not limited only to facsimile devices, and can be applied to the information processing device that requires operation in the power saving mode, for example, a personal computer, a communication device such as a portable telephone, a peripheral device such as a printer.

The present invention can be used as an information processing device capable of operating in the power saving mode, in particular, an information processing device in which the need to return from the power saving mode may arise by external factors, for example, an image forming device such as a facsimile device connected with the communication network.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An information processing device capable of operating in a power saving mode, the information processing device comprising:
a first control unit adapted and programmed to control a shift to the power saving mode and a return from the power saving mode;
a nonvolatile storage unit adapted to hold a program;
a volatile storage unit;
a second control unit adapted and programmed to load the program held in the nonvolatile storage unit to the volatile storage unit and execute the loaded program; and
an input/output port adapted to hold a set logical value even during the power saving mode; wherein
the first control unit is adapted and programmed to:
control, when shifting to the power saving mode, the volatile storage unit through the second control unit to continuously hold the program loaded in the volatile storage unit even in the power saving mode and set the logical value indicating the power saving mode to the input/output port, and then start the shift to the power saving mode; and
control the second control unit so that, when the information processing device is activated, the second control unit determines if the logical value indicating the power saving mode has been set to the input/output port, and when the logical value has been set to the input/output port, the second control unit recognizes the activation as the return from the power saving mode and executes the program held in the volatile storage unit, and when the logical value has not been set to the input/output port, the second control unit recognizes the activation as a normal activation that is not the return from the power saving mode and loads the program held in the nonvolatile storage unit to the voltage storage unit and executes the loaded program.

2. The information processing device according to claim 1, wherein the second control unit includes a register to store information and is adapted and programmed to:
save the information stored in the register in the volatile storage unit and set a flag indicating the power saving mode in the volatile storage unit before shifting to the power saving mode; and
determine if the flag has been set in the volatile storage unit when the information processing device is activated, and restore the information saved in the volatile storage unit in the register when the flag has been set in the volatile storage unit.

3. The information processing device according to claim 2, wherein when shifting to the power saving mode, the first control unit is programmed to save the information in the volatile storage unit and set the flag in the volatile storage unit, and then control the volatile storage unit through the second control unit to continuously hold the program loaded in the volatile storage unit even in the power saving mode and set the logical value to the input/output port.

4. The information processing device according to claim 2, wherein when the information processing device is activated, the first control unit is programmed to perform a program executing process in accordance with whether or not the logical value has been set, and then execute a restoring process in accordance with whether or not the flag has been set.

5. The information processing device according to claim 1, wherein the volatile storage unit performs a self-refresh function of not being able to input nor output the saved information but being able to continuously hold the information; and
the first control unit is adapted and programmed to:
control, when shifting to the power saving mode, the volatile storage unit through the second control unit to continuously hold the loaded program even in the power saving mode by having the volatile storage unit perform self-refresh; and
control, when the information processing device is activated, the second control unit so that when the logical value has been set to the input/output port, the second control unit releases the self-refresh in the volatile storage unit and then executes the program held in the volatile storage unit.

6. The information processing device according to claim 1, further comprising a third control unit that is adapted and programmed to continue to operate even in the power saving mode, wherein the input/output port is a port arranged in the third control unit.

7. The information processing device according to claim 6, wherein
the third control unit is programmed to activate the first control unit when detecting a return event from the power saving mode;
the first control unit is programmed to, when activated by the third control unit, activate the second control unit; and
the second control unit is programmed to, when activated by the first control unit, determine if the logical value has been set to the input/output port.

8. The information processing device according to claim 7, further comprising:
a communication front end unit that continues to operate even in the power saving mode; wherein the third control unit is programmed to activate the first control unit when detecting a request from the communication network by the front end unit.

9. The information processing device according to claim 1, further comprising:
a main substrate including a circuit mounted thereon that performs a control of image formation; and
a network substrate including mounted thereon an interface circuit that performs communication; wherein
the nonvolatile storage unit, the volatile storage unit, and the second control unit are mounted on the network substrate; and
the input/output port is mounted on the main substrate.

10. A management method of a power saving mode by an information processing device capable of operating in the power saving mode, the management method comprising the steps of:
a shift starting step of, when shifting to the power saving mode, controlling a volatile storage unit to continuously hold a program loaded from a nonvolatile storage unit to the volatile storage unit even in the power saving mode and setting a logical value indicating the power saving mode to an input/output port, and then starting shift to the power saving mode; and
a program executing step of, when the information processing device is activated, determining if the logical value indicating the power saving mode has been set to the input/output port, when the logical value has been set to the input/output port, recognizing the activation as a return from the power saving mode and executing the program held in the volatile storage unit, and when the logical value has not been set to the input/output port, recognizing the activation as a normal activation that is not the return from the power saving mode, loading the program held in the nonvolatile storage unit to the volatile storage unit and executing the loaded program.

11. The management method of the power saving mode according to claim 10, further comprising the steps of:
a shift pre-processing step of saving information stored in a register of a second control unit in the volatile storage unit, and setting a flag indicating the power saving mode in the volatile storage unit before shifting to the power saving mode; and
a restoring step of, when the information processing device is activated, determining if the flag has been set in the volatile storage unit and restoring the information saved in the volatile storage unit to the register when the flag has been set in the volatile storage unit.

12. The management method of the power saving mode according to claim 11, wherein the shift starting step is executed after executing the shift pre-processing step when shifting to the power saving mode.

13. The management method of the power saving mode according to claim 11, wherein the restoring step is executed after executing the program executing step when the information processing device is activated.

14. The management method of the power saving mode according to claim 11, further comprising the step of:
a program holding step of, when shifting to the power saving mode, controlling the volatile storage unit to continuously hold the loaded program even in the power saving mode by having the volatile storage unit perform self-refresh; wherein
in the program executing step, the program held in the volatile storage unit is executed after releasing the self-refresh in the volatile storage unit when the logical value has been set to the input/output port when the information processing device is activated.
